(19) United States
(12) Patent Application Publication
(10) Pub. No.: US 2010/0258105 A1
(43) Pub. Date: Oct. 14, 2010

(54) EGG-SHAPED OUTDOOR COOKER

(76) Inventor: John Lee SIMMS, II, Atlanta, GA (US)

Correspondence Address: GARDNER GROFF GREENWALD & VILLANUEVA. PC, 2018 POWERS FERRY ROAD, SUITE 800, ATLANTA, GA, 30339, US

(21) Appl. No.: 12/755,387

(22) Filed: Apr. 6, 2010

Related U.S. Application Data
(60) Provisional application No. 61/167,030, filed on Apr. 6, 2009.

(51) Int. Cl. A47J 37/07

(52) U.S. Cl. 126/25 R

(57) ABSTRACT

A non-ceramic, light-weight egg-shaped outdoor cooker made from formed sheet metal includes a double-walled kettle, with an inner wall spaced and insulated from an outer wall by an insulating layer. A domed lid is constructed similarly to the double-walled kettle and is hinged to the top of the kettle. By spacing the inner wall from the outer wall and providing an insulating layer, heat transfer to the outside of the cooker is greatly slowed. By constructing the structure of sheet metal, instead of ceramic, the cooker is light-weight, rugged, and economical to manufacture.

### CROSS-REFERENCE TO RELATED APPLICATION

This application claims the priority benefit of U.S. Provisional Patent Application Ser. No. 61/167,030, filed Apr. 6, 2009, which is hereby incorporated herein by reference.

### BACKGROUND OF THE INVENTION

The present invention relates to cookers and grills and in particular to egg-shaped, domed cookers. In the field of barbecue grills, outdoor cookers, smokers, and the like, a market has developed for egg-shaped, domed cookers. An example of such is shown in U.S. Design Patent Des. 201,937 to Johnson.

Sometime in the 1960's, one manufacturer made and sold ceramic “Kamado” cookers in the United States. These cookers were generally egg-shaped with a hinged, domed top and made of high-fire ceramics with a high gloss ceramic glaze to retain a glossy exterior color over time despite exposure to the elements. More recently, the “Big Green Egg”® has been manufactured and sold widely. This product is also a ceramic cooker, shaped like an egg with a hinged, domed top and having an enameled (fired) exterior finish.

Products of the sorts just described cook well, but generally suffer from being very heavy (largely due to the use of thick ceramic to function as both structure and insulation). As a result, such ceramic egg-shaped cookers are heavy and cumbersome to move and operate. They are also expensive and can be fragile. Accordingly, there remains a need in the art for an egg-shaped cooker that is relatively inexpensive, light, and durable. It is to the provision of such that the present invention is primarily directed.

### SUMMARY OF THE INVENTION

Briefly described, in a first preferred form the present invention comprises an egg-shaped outdoor cooker that is lightweight, making the cooker easier to purchase and take home, easier to set up and install, and easier to move around. To obtain the relatively light weight, the cooker is not made out of thick ceramic for both structure and insulation. Instead, the cooker is formed from sheet steel (or other metal). Preferably, the cooker is a double-walled kettle, with an inner wall spaced and insulated from an outer wall by an insulating layer. A domed lid preferably is constructed similarly and preferably is hinged to the top of the metal kettle.

The insulating layer can comprise fibrous insulation, foam insulation, metal honeycomb, or even some selected (limited) use of ceramic insulation. By spacing the inner wall from the outer wall, heat transfer from the fire box to the outside of the cooker is greatly slowed. The insulating layer further retards heat transfer to the outer wall, allowing the cooker to cook with less fuel consumption.

By using thin metal (sheet metal), instead of thick ceramic, to provide the structure and strength of the egg-shaped cooker, weight is reduced substantially. In addition, the insulating layer described herein also provides adequate insulation with much less weight than the traditional thick ceramic.

The net result is a cooker that has the traditional egg-shaped configuration and the cooking characteristics attendant thereto, but with much less weight. This design saves in manufacturing costs, shipping costs, etc., and makes it easier for the consumer to move the product around.

### BRIEF DESCRIPTION OF THE DRAWINGS

FIG. 1 is a front perspective illustration of an egg-shaped outdoor cooker according to preferred form of the present invention.

FIG. 2 is a side view of the egg-shaped outdoor cooker of FIG. 1.

FIG. 3 is a perspective illustration of a detailed portion of the outdoor cooker of FIG. 1.

FIG. 4 is a bottom perspective view of a portion of the outdoor cooker of FIG. 1.

FIG. 5 is an exploded, perspective view of a portion of the outdoor cooker of FIG. 1.

FIG. 6 is another exploded, perspective view of a portion of the outdoor cooker of FIG. 1.

FIG. 7A is a side sectional view of a portion of the outdoor cooker of FIG. 1.

FIG. 7B is a side sectional view of a portion of the outdoor cooker of FIG. 1, in an alternate form.

FIG. 7C is a side sectional view of a portion of the outdoor cooker of FIG. 1, in another alternate form.

### DETAILED DESCRIPTION

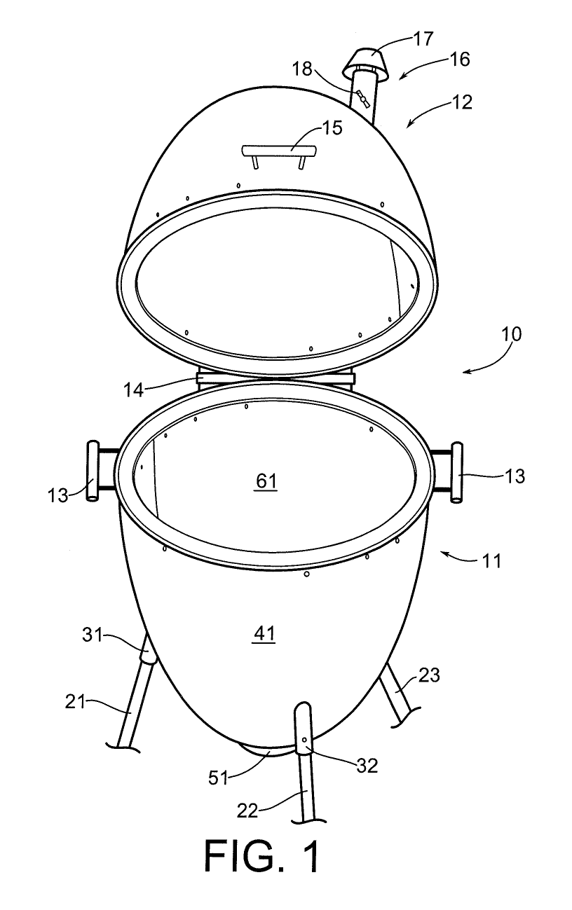

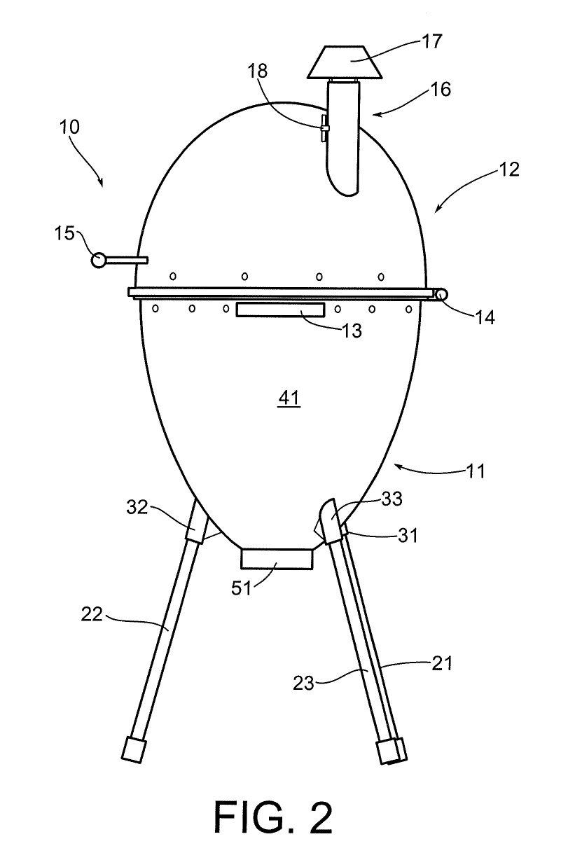

Referring now in detail to the drawing figures, wherein like reference numerals represent like parts throughout the several views, FIGS. 1 and 2 show an egg-shaped outdoor cooker 10 according to a first preferred form of the invention. The egg-shaped outdoor cooker 10 is lightweight, making the cooker easier to purchase and take home, easier to set up and install, and easier to move around. The cooker is also durable and rugged, as well as economical to manufacture. Advantageously, the cooker 10 is not made out of thick ceramic for both its structure and insulation. Instead, the cooker 10 is made from sheet metal steel (or other metal). Preferably, the cooker includes a double-walled kettle 11, with an inner wall spaced and insulated from an outer wall by an insulating layer. A domed lid 12 preferably is constructed similarly and preferably is hinged to the top of the metal kettle 11 by a hinge 14. The metal kettle 11 optionally can have a pair of handles 13 positioned thereon. The domed lid 12 also optionally can have a handle 15 positioned thereon, preferably on a side opposite to the side where the hinge 14 is connected to the lid 12.

In an alternate form (not shown in the figures), the side handles 13 can be dispensed with in favor of shelves and a front handle can be positioned on the kettle 11, generally below handle 15.

Together, the lower kettle 11 and the upper domed lid 12 form a generally egg-shaped or ovoid cooking enclosure. The kettle 11 or lower portion is shaped like part of an egg. Likewise, the upper portion or domed lid 12 is also shaped like a complementary part of an egg. In a preferred form, the top of the lid 12 is shaped like the “big end” of an egg, while the bottom of the kettle 11 is shaped like the “small end” of an egg, such that together they give the appearance of an egg that is oriented “small end” down. The kettle 11 and the domed lid 12 are sized and configured such that with the domed lid 12 positioned over the kettle 11, they are substantially the same size and shape where they meet so that they give the appearance of a more or less egg-shaped enclosure. If the domed lid 12 is to be a slightly different diameter than the kettle 11, it is preferred that the domed lid 12 be slightly larger, rather than slightly smaller, than the kettle 11.

As used herein, “egg-shaped” refers to having substantially the appearance/outer shape of an ovoid egg or a portion thereof.

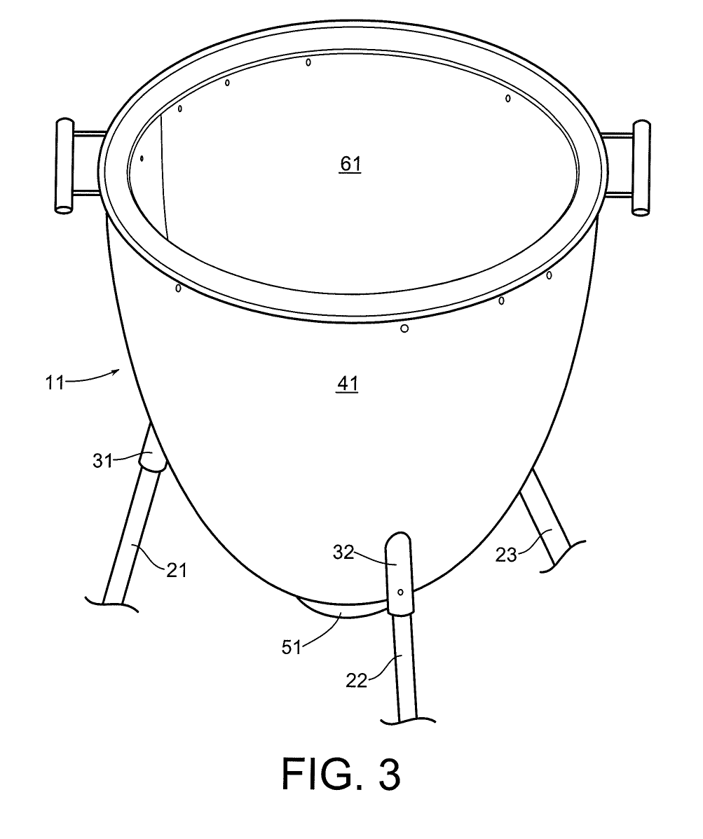

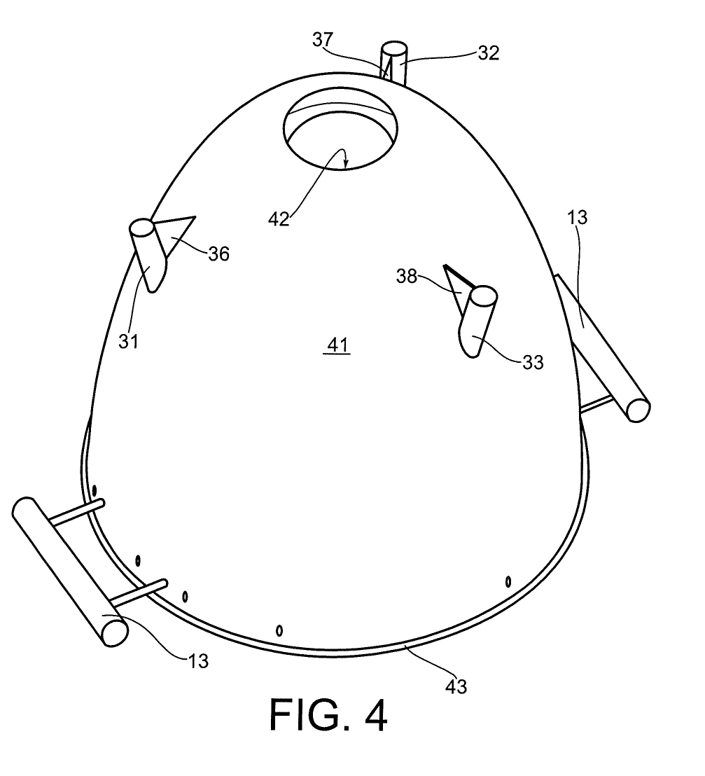

The kettle or lower portion 11 of the enclosure is supported upon three legs 21, 22, and 23, which in FIG. 1 are shown cut off for simplicity of illustration. As best seen in FIGS. 3 and 4, the legs 21, 22, and 23 are received in leg sockets 31, 32, and 33. The leg sockets are welded to the outer shell 41 of the kettle 11 and are each reinforced by a gusset 36, 37, and 38 which is welded to both the leg socket and the outer shell 41. Optionally, the legs can be removed or omitted in situations where the cooker is to be inserted into a more or less permanent structure, such as in an outdoor cabinet or console. A bead or small flange 43 can be formed at the top edge of the outer shell 41 to reinforce the top edge, if desired.

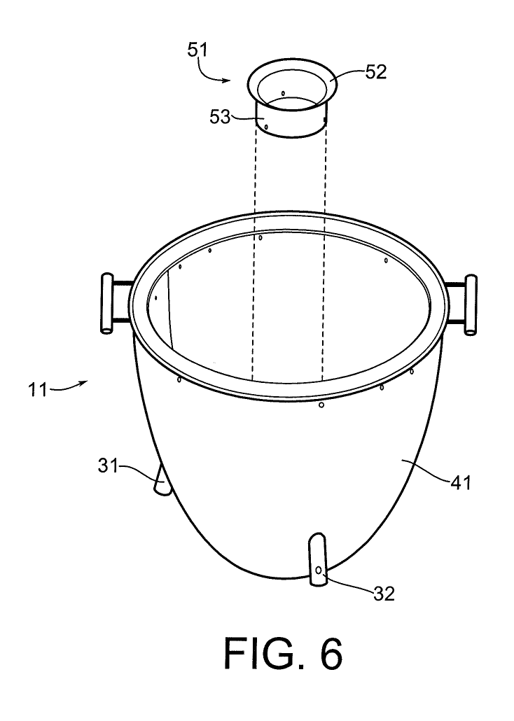

A circular opening 42 is formed in the bottom of the outer shell 41. As seen in FIGS. 1, 6, and 7A, the opening 42 receives an ash trap or cleanout trap 51 therein. The ash trap 51 is generally cylindrical and is adapted to be dropped in from above and easily removed from the kettle 11. A small annular flange 52 (slightly angled) is formed atop a cylindrical portion 53 of the ash trap to position it in place and keep it from falling through the bottom of the kettle 11. Optionally, an air inlet control valve can be incorporated into the trap 51. Optionally, an air inlet control valve can be positioned elsewhere on the kettle, although it is preferred that the air inlet control valve be positioned below or level with the fire (fuel).

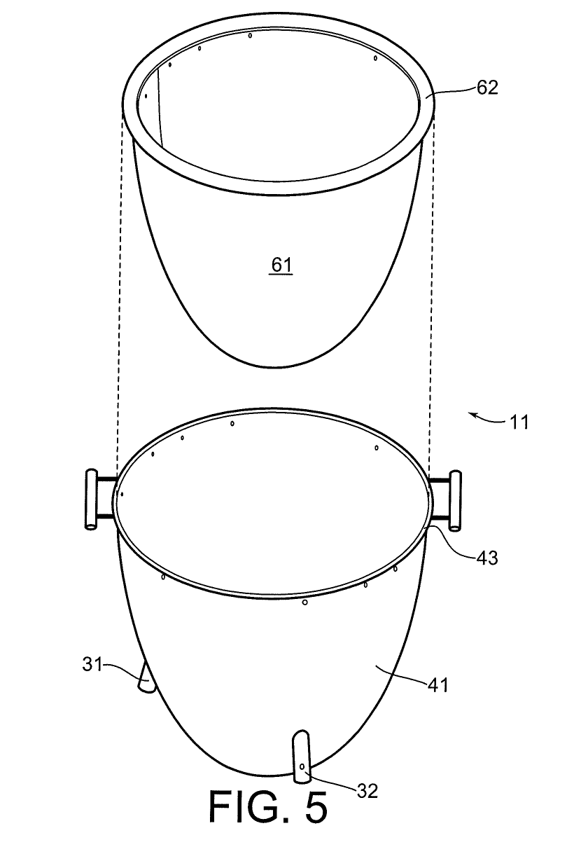

At best seen in FIG. 5, the kettle 11 also includes an inner liner or inner shell 61. Both the outer shell or outer liner 41 and inner liner or inner shell 61 are each generally egg-shaped, as seen in the illustrations. Those skilled in the art will understand, however, that the relative dimensions and shape can vary somewhat from that shown and still remain egg-shaped, as the shape shown is merely illustrative of the present invention. The inner and outer shells of the kettle 11 are of the same general overall shape, but are sized to allow the inner shell to nest within the outer shell and leave a uniform gap or space therebetween.

The inner liner or inner shell 61 also includes a broad upper flange 62 which functions to support the inner liner 61 atop the flange 43 of the outer liner 41. This also functions to seal the space therebetween against the elements, primarily to keep rain and debris from finding their way into the insulating space between the outer shell 41 and inner shell 61. Optionally, a sealing gasket can be provided at this location to seal the lid 12 to the kettle 11 when closed.

The size and shape of the inner liner 61 in the outer liner 41 are configured to provide an insulating space between the two. This insulating space can be filled substantially with fibrous insulation, foam insulation, metal honeycomb, combinations thereof, or even some selected use of ceramic insulation. The insulating layer is preferably about 0.5 inches to 2 or 3 inches thick, and more preferably it is 1.5 inches (3.81 cm) thick.

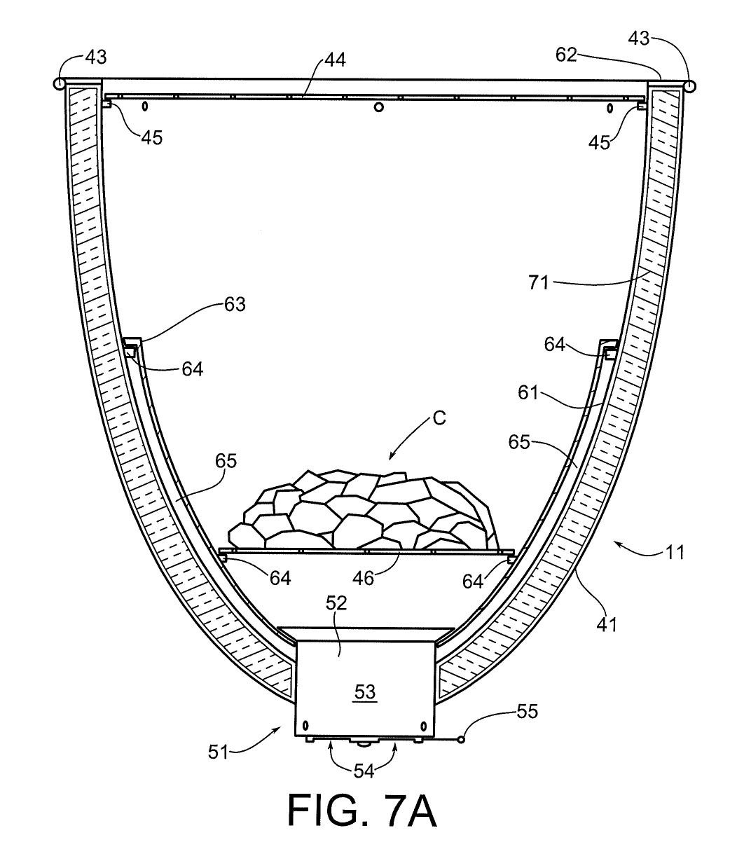

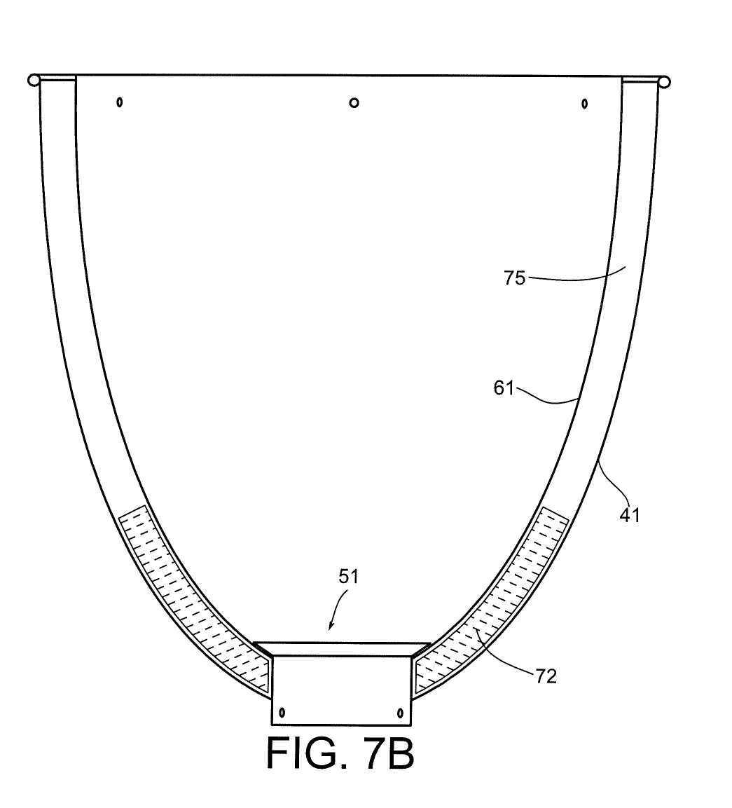

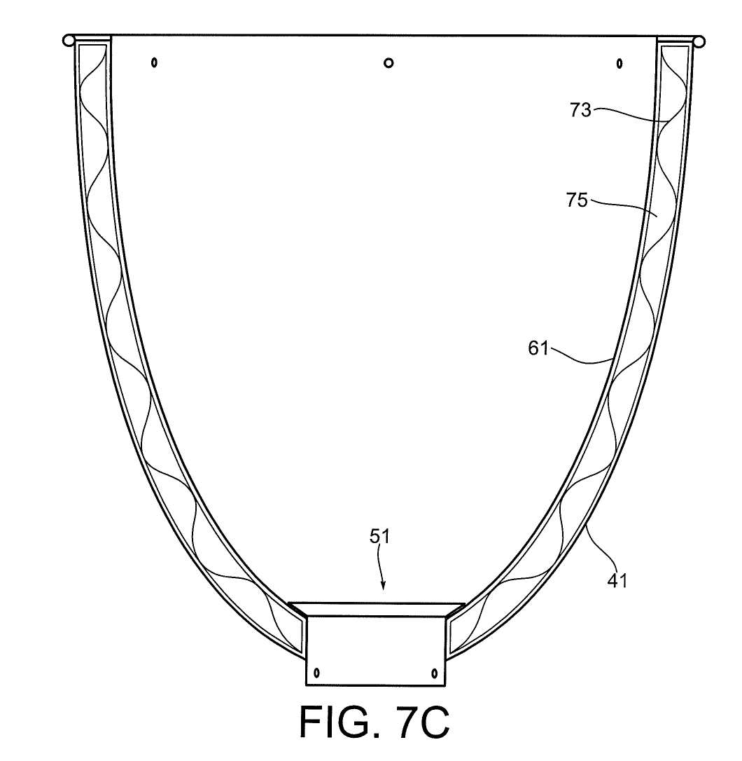

FIG. 7A shows the insulating space substantially filled with an insulating layer 71. As shown, the insulating layer 71 can substantially fill the entire insulating space from top to bottom and around all sides. Alternatively, insulating material can be provided in only portions of the insulating space, as desired. For example, FIG. 7B shows the insulating space only partly filled with an insulating section 72 of refractory material (ceramic). In a preferred form, the insulation is an oven-grade fiberglass insulation material.

FIG. 7C shows the insulating space 75 substantially filled with an insulating layer 73 of metal honeycomb.

As described briefly above, the domed lid 12 preferably has the same form of construction (double-walled sheet metal, insulated) as that of the kettle 11. Moreover, the domed lid 12 preferably is provided with a vent 16, such as a smoke stack, as seen in FIGS. 1 and 2. The vent preferably includes a control element 18, such as a butterfly valve, to control the flow of exhaust therethrough, so as to control cooking temperature, as is well known in the art. The vent 16 can additionally have a cap 17 positioned over the top thereof for protecting the kettle from rain, snow and falling debris, while allowing the egress of smoke that rises through the vent 16. The vent can be positioned in various places. Once suitable location is at the very apex of the domed lid. But other positions in the upper portion of the domed lid are suitable also.

Similarly, the kettle 11 can be provided with an air inlet 54 and a control element 55 to control air flow into the kettle 11 (see FIG. 7A). In one form, the air inlet 54 and the control element 55 are located on the bottom of the ash trap 51. Alone or together, these control elements can control the amount of fresh air provided to the fire to control the cooking temperature. The fire can consume wood, charcoal, or gaseous fuels. In a preferred embodiment, the cooker is adapted to cook with wood or charcoal C, as seen in FIG. 7A. As mentioned previously, optimally the air inlet should be below or level with the fuel.

The kettle 11 supports a grate 44 for supporting food thereon, held by a lip 45 positioned on the inner shell 61, as best seen in FIG. 7A. Optionally, the grate 44 can be suspended by adjustable hangers such that the height of the grate over the fire can be adjusted. The kettle 11 can optionally include a fire bowl 63, as seen in FIG. 7A. In a preferred form the fire bowl 63 is shaped substantially similar to the kettle 11 and includes an aperture located at the bottom end, to allow the partial passage of the ash trap 51 therethrough. The fire bowl 63 is supported by an inner lip 64 positioned on the inner shell 61. The fire bowl 63 is preferably made of thin sheet metal, but other appropriate materials can be used. The inner surface of the fire bowl 63 can additionally have a lip 64, whereon a grate or platform 46 rests. The grate or platform can hold any suitable solid fuel, such as the charcoal C. The space between the fire bowl 63 and the inner shell 61 comprises a secondary insulation layer 65, which can be filled with a suitable insulation or left empty to provide an air gap insulation. The secondary insulation layer 65 is preferably about 0.5 inches to 3 inches thick, most preferably the secondary insulation layer is about 1 inch thick. However, those skilled in the art will recognize that the thicknesses of the insulation layers and the particular insulations used can be varied, as desired.

By spacing the inner wall from the outer wall, heat transfer from the fire to the outside of the cooker is greatly slowed. The insulating layer further retards heat transfer to the outer wall. By using sheet metal, instead of thick ceramic, to provide the structure and strength of the egg-shaped cooker, weight is reduced substantially. In addition, the insulating layer described herein also provides adequate insulation with much less weight than the traditional thick ceramic. This sheet metal structure, as compared to a ceramic structure, is also rather durable, rugged, and economical to manufacture.

While the invention has been described with reference to preferred and example embodiments, it will be understood by those skilled in the art that a variety of modifications, additions and deletions are within the scope of the invention, as defined by the following claims.

What is claimed is:

1. An outdoor cooker comprising:
a generally egg-shaped enclosure comprising a lower portion and an upper portion, the upper portion being shaped generally like part of an egg and the lower portion also being shaped generally like part of an egg, and wherein with the upper portion positioned over the lower portion, where the upper portion meets the lower portion the upper portion and lower portion are similarly sized and shaped; and
the lower portion of the enclosure comprising a generally egg-shaped sheet metal outer shell, a generally egg-shaped sheet metal inner shell, and an insulating layer positioned between the sheet metal outer shell and the sheet metal inner shell.

2. An outdoor cooker as claimed in claim 1 wherein the upper portion of the enclosure comprises a sheet metal outer shell, a sheet metal inner shell, and an insulating layer positioned between the sheet metal outer shell and the sheet metal inner shell.

3. An outdoor cooker as claimed in claim 1 wherein the insulating layer comprises fiber glass insulation.

4. An outdoor cooker as claimed in claim 1 wherein the insulating layer comprises a layer of heat-resistant foam.

5. An outdoor cooker as claimed in claim 1 wherein the insulating layer comprises ceramic.

6. An outdoor cooker as claimed in claim 1 wherein the insulating layer comprises fibrous insulation.

7. An outdoor cooker as claimed in claim 1 wherein the insulating layer comprises metal honeycomb.

8. An outdoor cooker as claimed in claim 1 wherein the lower portion includes an air inlet for communicating fresh air to within the inner shell, and wherein the upper portion includes an exhaust outlet, and the outdoor cooker further includes a flow control element which can be manipulated to control the airflow and thereby can control the cooking temperature.

9. An outdoor cooker as claimed in claim 8 wherein the lower portion defines a fire zone for burning solid fuel.

10. An outdoor cooker as claimed in claim 2 wherein the upper portion is pivotally attached to the lower portion.

11. An outdoor cooker as claimed in claim 2 wherein the upper portion is movably positioned over the lower portion.

12. An outdoor cooker as claimed in claim 1, wherein a fire bowl is positioned in the inner shell of the lower portion of the enclosure.

13. An outdoor cooker as claimed in claim 12, wherein a secondary insulation layer exists between the fire bowl and the inner shell of the lower portion of the enclosure.

14. An outdoor cooker as claimed in claim 13, wherein the secondary insulation layer comprises an air gap.

15. A non-ceramic egg-shaped outdoor cooker comprising:
a double-walled sheet metal kettle having an inner shell and an outer shell with an insulating gap between the inner shell the outer shell, the kettle being formed in the general shape of part of an egg; and
a double-walled sheet metal lid hinged to the kettle and having an inner shell and an outer shell with an insulating gap between the inner shell the outer shell, the lid being formed in the general shape of part of an egg, with the shape of the lid forming a complementary shape to the kettle such that when brought together the lid and the kettle are collectively generally egg-shaped.

16. A non-ceramic egg-shaped outdoor cooker as claimed in claim 15 wherein the insulating gap is substantially filled with glass fiber insulation.

17. A non-ceramic egg-shaped outdoor cooker as claimed in claim 15 wherein the insulating gap in the kettle is at least partly filled with insulation.

18. A non-ceramic egg-shaped outdoor cooker as claimed in claim 15 wherein the insulation comprises fibrous insulation.

19. A non-ceramic egg-shaped outdoor cooker as claimed in claim 15 wherein the insulation comprises fibrous insulation.

20. A non-ceramic egg-shaped outdoor cooker as claimed in claim 15 wherein a top of the lid is shaped like the big end of an egg, while a bottom of the kettle is shaped like the small end of an egg, such that together they give the appearance of an egg oriented small end-down.
